(19) United States
(12) Patent Application Publication
(10) Pub. No.: US 2006/0182295 A1
(43) Pub. Date: Aug. 17, 2006

(54) Dynamic hearing assistance system and method therefore

(75) Inventors: Evert Dijkstra, Fontaines (CH); David Fabry, Rochester, MN (US)

Correspondence Address: PEARNE & GORDON LLP, 1801 EAST 9TH STREET, SUITE 1200, CLEVELAND, OH, 44114-3108, US

(73) Assignee: Phonak AG

(21) Appl. No.: 11/055,902

(22) Filed: Feb. 11, 2005

(51) Int. Cl. H04R 25/00

(52) U.S. Cl. 381/315; 381/312

(57) ABSTRACT

A system and method for hearing assistance with dynamic loudness adaptation of audio signals, first audio signals being captured by a first microphone (26) and transmitted by a transmission unit (22) over a communication channel (27) to a receiver (24) connected to a hearing instrument (15), and second audio signals being captured by a second microphone (36), wherein a classification index is determined by means of a classification unit (34) based on the amplitude and/or frequency and/or temporal characteristics of the first and/or second audio signals, wherein, based on the classification index, the predefined amplitude and/or frequency ratio of the first audio signals relative to the second audio signals is adapted by a central unit (35), and wherein the adapted first and second audio signals are reproduced by means of a reproduction unit (38), within the mentioned ratio. This system and method provide a high level of comfort and better understanding in all auditory situations.

### FIELD OF THE INVENTION

The present invention relates to dynamic hearing assistance systems, such as assistive listening systems, and it relates in particular to dynamic loudness adaptation of audio signals with respect to hearing assistance systems and devices therefore. More specifically, the present invention is directed to FM assistive listening systems and devices with a dynamical loudness adaptation of audio signals.

### BACKGROUND ART

In recent years, hearing assistance systems such as assistive listening systems (ALS) have become widely used for alleviating difficulties that people with a hearing impairment are faced with in daily life. The improved technology, like miniaturization of electronic elements and use of wireless transmission techniques, has helped to achieve systems that are able to provide effective assistance to hearing-impaired people.

Frequency modulated (FM) hearing systems are one of the systems used today. These systems use the FM transmission techniques to transmit wirelessly signals from the source to the listeners. In particular, FM systems have been standard equipment for children with hearing loss in educational settings for many years. Their merit lies in the fact that a microphone placed a few inches from the mouth of a person speaking receives speech at a much higher level than one placed several feet away. This increase in speech level means equally an increase in signal-to-noise ratio (SNR) due to the direct wireless connection to the listener's amplification system. The resulting improvements of signal level and signal-to-noise ratio in the listener's ear are recognized as the primary benefits of FM use, as hearing-impaired individuals are at a significant disadvantage when processing signals with a poor acoustical signal-to-noise ratio.

Most FM systems in use today provide two or three different operating modes. The choices are to get the sound from:

(1) the hearing instrument microphone alone,

(2) the FM microphone alone, or

(3) a combination of FM and hearing instrument microphones together.

Most of the time, the FM system is used in the FM plus hearing instrument combination (often called FM+M or FM+ENV). This operating mode allows a main person speaking to have a consistent signal to the listener's ear while the integrated hearing instrument microphone also stays on so that environmental sounds can be heard. This allows users to hear and monitor their own voices, as well as voices of other people or environmental noise, as long as the loudness balance between the FM signal and the signal coming from the hearing instrument microphone is properly adjusted. The so-called “FM advantage” measures the relative loudness of signals when both the FM signal and the hearing instrument microphone are active at the same time. As defined by the ASHA (American Speech-Language-Hearing Association 2002), FM advantage compares the strengths of the FM signal and the local microphone signal when the speaker and the user of an FM system are two meters away from each other. In this example, the voice of the speaker will travel 30 cm to the input of the FM microphone at a strength of approximately 80 dB-SPL, whereas only about 65 dB-SPL will remain of this original signal after traveling the 2 m distance to the microphone in the hearing instrument. The ASHA guidelines recommend that the FM signal should sound 10 dB louder than the hearing instrument's microphone signal at the output of the user's hearing instrument.

In the patent application US 2002/0037087 a method for identifying a transient acoustical scene is described. The method according to US 2002/0037087 is based on an extraction of signal characteristics, followed by a separation of different sound sources and an identification of different sounds. Contrary to the prior art automatic classification of acoustical surroundings that involves the extraction of different characteristics from the input signal and a pattern-recognition modeling only the static properties of the sound categories, the disclosed method uses a dynamic approach. However, the method described in the patent application US 2002/0037087 does not give any suggestion about the automatic adaptation of the audio signal ratio captured by different microphones.

A similar method for operating a hearing device is described in the patent application US 2002/0090098. According to US 2002/0090098, the sound classification is carried out by means of Hidden Markov Models (HMMs), and used for determination of the transient auditory scene and/or voice and word recognition.

In the patent application WO 02/032208 another method for determining an acoustical environment situation is described wherein the acoustical input signal for classification is treated at two processing stages. Sound classification according to WO 02/032208 is based on multiple feature extraction and classification stages.

In the patent application US 2002/0150264, a method for eliminating spurious signal components in an input signal of an auditory system is disclosed. According to the described method the noise components in the input signal are eliminated when auditory features are used to characterize target and noise components and re-synthesize the target based on the sound classification with auditory features.

Heretofore, depending on the type of hearing instrument, the output of the FM receiver is adjusted in such a way that the FM advantage is either fixed or programmable by a professional. However, the FM advantage should be determined according to the particular listening situation (quiet environment, loud background noise, lecture in the school, conference etc.). Consequently, any fixed FM advantage is only a compromise, and cannot offer an optimal result in all listening situations. The existing hearing assistance methods do not provide a solution to this problem.

### DISCLOSURE OF INVENTION

Therefore, a first and main object of the invention is to provide a hearing assistance system and a method therefore that are capable of fulfilling the above-discussed requirements and which do not have the mentioned drawbacks.

These and still other objects of this invention are attained by the system and the method for dynamic loudness adaptation of audio signals that is defined in the independent patent claims. Further special or preferred embodiments follow moreover from the dependent claims and from the specification.

The above-mentioned objects are achieved through the present invention in that, in a system for hearing assistance, first audio signals are captured by a first microphone and transmitted by a transmission unit over a communication channel to a receiver connected to, or integrated into, a hearing instrument, while second audio signals are captured by a second microphone, wherein a classification index is determined, by means of a classification unit, based on the amplitude and/or frequency and/or temporal characteristics of the first and/or second audio signals, while, based on the classification index, the predefined amplitude and/or frequency ratio of the first audio signals relative to the second audio signals is adapted by a central unit, and the adapted first and second audio signals are reproduced by means of a reproduction unit, within the mentioned ratio. Such systems and devices therefore have the advantage that the relative loudness of the first audio signals with respect to the second audio signals or the FM advantage is adapted dynamically in real-time. Applying the classification index, the system uses the first and second audio signals to determine the best ratio of amplitudes, and correspondingly adapts the output of the system in real time. Such systems offer much better hearing performance for their users, as the FM advantage is constantly adapted to correspond to the given auditory situation.

In an embodiment variant, the determination of the classification index is based on temporal and/or spectral analysis. This embodiment variant has the advantage, among other things, that sophisticated temporal and/or spectral analysis techniques can be used in order to classify the auditory situation based on the first and second audio signals. Use of these techniques improves the precision of the auditory scene analysis and gives more adequate data that result in beneficial adaptation of the audio signals.

In another embodiment variant, the determination of the classification index is based on auditory classification techniques. This embodiment variant has the advantage, among other things, that many conventional hearing instruments and other devices used in the assistive listening systems implement auditory classification techniques based on audio signals. The use of these auditory classification techniques can simplify the overall system still allowing the user to benefit from the dynamic and real-time adaptation of the FM advantage.

In a further embodiment variant, the classification index takes one of the predefined discrete values. This embodiment variant has the advantage, among other things, that a couple of most common FM advantage values can be used to simplify the determination of the classification index and reduce costs and complexity of the system, still allowing users to benefits from the dynamic and real-time adaptation of the FM advantage.

In another embodiment variant, the classification index takes any one value out of a predefined range. This embodiment variant has the advantage, among other things, that the most appropriate value of the FM advantage can be determined exactly, and thus the user can fully benefit from the system with an adaptive FM advantage in each auditory situation.

In an embodiment variant, the classification unit is included in the hearing instrument. This embodiment variant has the advantage, among other things, that the transmission system can be kept simple and the whole classification and adaptation of the audio signals can be performed in the hearing instrument itself, using potentially existing facilities of the hearing instruments.

In a further embodiment variant, the classification unit is comprised in the receiving unit. This embodiment variant has the advantage, among other things, that the whole classification of the audio signals can be performed in a separate device used in connection with a hearing instrument, so that the system can be implemented using basically any arbitrary conventional hearing device. Moreover, users would not need to replace their current hearing instruments, and would still benefit from the dynamic FM advantage adaptation.

In another embodiment variant, the classification unit is included in the transmission unit. This embodiment variant has the advantage, among other things, that the whole classification of the audio signals can be performed at the beginning of the signal processing, so that the classification can be done once for all users in the system. The processing would therefore be reduced to a minimum, which would lead to a lower power consumption in the portable devices and a longer lifetime for them. Again, users would not need to replace their current hearing instruments, and would still benefit from the dynamic FM advantage adaptation. Due to the short distance between the source of speech and the capturing microphone, the speech detection and recognition can be performed in a simple way and with a high degree of precision.

In still another embodiment variant, the first audio signals and control data comprising at least the classification index are transmitted from the classification unit over the communication channel, while the predefined amplitude and/or frequency ratio of the first audio signals relative to the second audio signals is adapted by a central unit based on the received control data. This embodiment variant has the advantage, among other things, that in addition to the FM advantage related data, the transmitted data can also contain general control data by means of which the hearing instruments of all users of the system can be controlled from a single point. As an example, the spectrum of the communication channel can be divided to transport both audio signals and information needed to perform the adaptation of the FM advantage in the hearing instruments of all users of the system.

In another embodiment variant, the predefined amplitude and/or frequency ratio of the first audio signals relative to the second audio signals is adapted in the hearing instrument based on the received control data. This embodiment variant has the advantage, among other things, that the receiving unit can be kept simple, while the adaptation is performed in the specialized hearing instruments.

In another embodiment variant, the predefined amplitude and/or frequency ratio of the first audio signals relative to the second audio signals is adapted in the receiving unit based on the received control data. This embodiment variant has the advantage, among other things, that the control data can be used directly in the receiving unit to adapt the received audio signals, keeping the hearing instrument simple, without need to replace hearing instruments currently in use.

In an embodiment variant, the communication channel is a frequency modulation (FM) radio channel. This embodiment variant has the advantage, among other things, that the FM radio channel allows for very good SNR values and that systems using the FM radio channel are today widespread. As the FM signal is not affected by typical noise sources, and the dedicated frequencies used reduce the possibility of radio interference, FM systems provide a very good audio quality, and the transmission range allows better coverage of large auditoriums.

At this point, it should be stated that, besides the method for dynamic loudness adaptation of audio signals according to the invention, the present invention also relates to a system for carrying out the method.

### BRIEF DESCRIPTION OF THE DRAWINGS

Other features and advantages of the invention will become apparent from the following description of an embodiment thereof, as a non-limiting example, when read in connection with the accompanying drawing in which:

FIG. 1 is a view of the conventional prior art hearing aid system.

FIG. 2 is a view of the conventional prior art FM assistive listening system (ALS).

FIG. 3 is a block diagram of a segment of a particular embodiment of the hearing assistance system according to the invention.

### MODE(S) FOR CARRYING OUT THE INVENTION

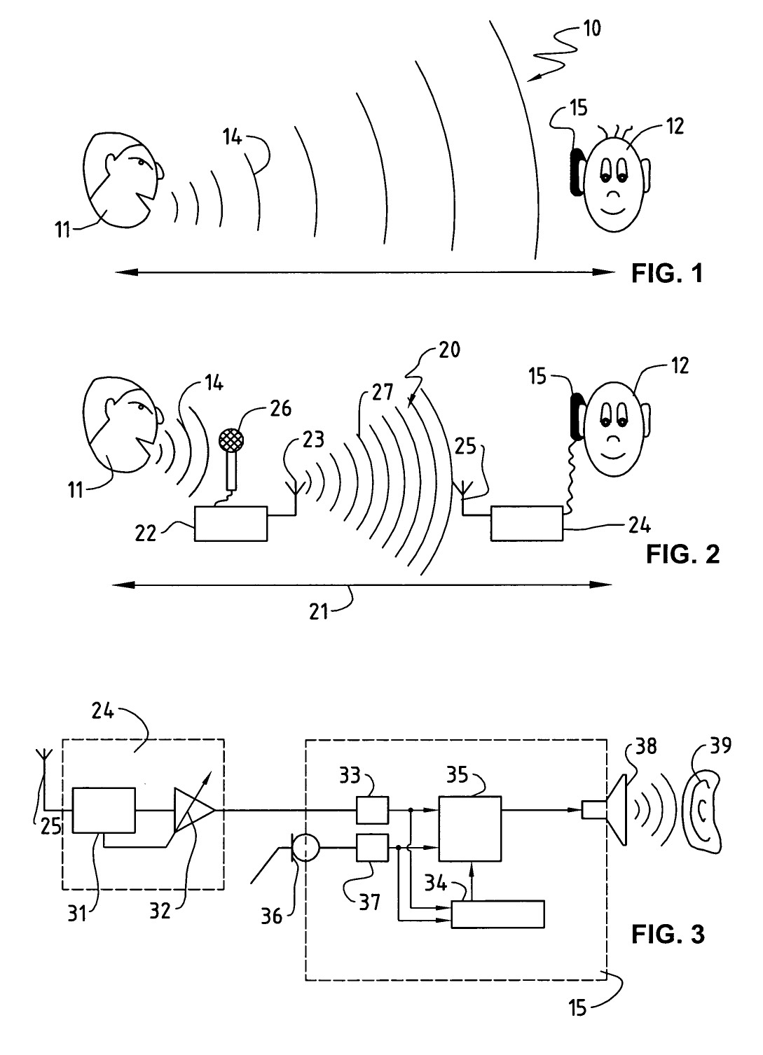

FIG. 1 shows a conventional hearing assistance system 10 with a speaker 11 and a listener 12, whereas the listener uses a hearing instrument 15. The speech audio signals 14 proceeding from the speaker's 11 mouth propagate through the air to reach the hearing instrument 15 of the listener 12. A microphone located at the hearing instrument is able to capture the waves carrying the audio signals. These audio signals 14 are then treated by the hearing instrument 15, and finally reproduced to the listener via a loudspeaker and/or any other corresponding reproduction means located at an appropriate place at the hearing instrument 15.

It is now widely accepted that different listening environments require different signal processing strategies. The main requirements for optimal communication in quiet environments are audibility and good sound quality, whereas in noisy environments the main goal is to improve the Signal-to-Noise Ratio (SNR) to allow better speech intelligibility. Therefore, modern hearing instruments 15 typically provide several hearing programs that change the signal processing strategy in response to the changing acoustical environment. Such instruments offer programs which have settings that are significantly different from each other, and are designed especially to perform optimally in specific acoustical environments. Most of the time, hearing programs permit accounting for acoustical situations such as quiet environment, noisy environment, one single speaker, a multitude of speakers, music, etc. In early implementations, hearing programs had to be activated either by means of an external switch at the hearing instrument 15 or with a remote control. Nevertheless, most recent development in hearing instruments has moved to automatic program selection based on an internal automated analysis of the captured sounds. There exist already a few commercial hearing instruments which make use of sound classification techniques to select automatically the most appropriate hearing program in a given acoustical situation. The techniques used include Ludvigsen's amplitude statistics for the differentiation of impulse-like sounds from continuous sounds in a noise canceller, modulation frequency analysis and Bayes classification or the analysis of the temporal fluctuations and the spectrum. Other similar classification techniques are appropriate for the automatic selection of the hearing programs, such as Nordqvist's approach where the sound is classified into clean speech and different kinds of noises by means of LPC coefficients and HMMs (Hidden Markov Models) or Feldbusch' method that identifies clean speech, speech babble, and traffic noise by means of various time- and frequency-domain features and a neural network. Finally, some systems are inspired by the human auditory system where auditory features as known from auditory scene analysis are extracted from the input signal and then used for modeling the individual sound classes by means of HMMs.

FIG. 2 shows a conventional FM assistive listening system 20 with a speaker 11 and a listener 12, the speaker using a transmission unit 22 and the listener using a receiving unit 24 connected to a hearing instrument 15. Acoustic sounds produced by the speaker propagate through the air to reach the microphone 26 connected to the transceiver 22. These acoustic sounds are then recorded by the microphone 26. The input signal is then finally sent over the FM radio link 27 by means of the antenna 23. A second antenna 25, connected to a remote receiving unit 24, receives the audio signals 14 sent over the FM radio link 27, treats them correspondingly, and transmits them to the listener's 12 hearing instrument 15, where these audio signals 14 are reproduced for the listener via a loudspeaker and/or any other corresponding reproduction means located at an appropriate place at the hearing instrument 15. With a personal FM system, the speaker's voice is picked up via an FM microphone 26 near their mouth, and is converted to an electrical waveform. The waveform is transmitted as an FM radio signal to a personal receiving unit 24 worn on the body by the listener 12. The electrical signal is then converted back to an acoustical signal and transmitted to the listener's ear(s) via the hearing instrument 15. Another type of FM systems is known as behind-the-ear (BTE) FM systems. These BTE FM systems have an FM receiving unit 24 built into or attached to a BTE hearing instrument 15. As BTE FM technology does not require cords or wires, BTE FM systems are usually more durable than the body-worn FM systems. Moreover, BTE FM systems reduce the stigma associated with the more visible body-worn FM systems, and are therefore more acceptable.

FIG. 3 shows a diagram of a segment of a particular embodiment of the hearing assistance system according to the invention. Illustrated in FIG. 3 are the receiving unit 24 and the hearing instrument 15 interconnected either by means of a wire and/or any other physical contact. A person skilled in the art would easily see that the interconnection of the receiving unit 24 and the hearing instrument 15 can also be implemented in a number of other ways and even that the receiving unit 24 can be integrated into, or attached to, the hearing instrument 15, either as a fully integrated internal module or a detachable device that can be easily plugged in or removed, as the situation requires. The radio signals are received over the radio link 27 by the antenna 25 connected to the receiving unit 24. The receiving unit 24 can contain various modules 31/32 performing different tasks with respect to the signal processing, such as amplification, digital-to-analog and/or analog-to-digital conversion, sampling, filtering and any other task. The radio signals received over the radio link 27 may contain speech and/or music audio signals as well as any other kind of control data. In particular, the received radio signals can contain digital data that can be used for remotely controlling and/or directing modules in the receiving unit 24 and/or hearing instrument 15.

In an embodiment variant, the central unit 35 is embedded in the hearing instrument 15. In this embodiment variant, the hearing instrument 15 comprises a microphone 36 for capturing environmental sounds, such as own voice and/or speech from the fellow students in school classes. The hearing instrument 15 further comprises a loudspeaker 38 that reproduces audio signals to the listener's ear 39. In the particular embodiment variant, the audio signals proceeding from the microphone 36 are reproduced together with the audio signals proceeding from the remote speaker and received over the communication channel 27 by means of the receiving unit 24. The hearing instrument can contain various modules and units dedicated to signal processing and in particular a processing module 33 that processes signals received from the receiving unit 24, a classification unit 34 for determining the classification index based on the amplitude and/or frequency and/or temporal characteristics of the audio signals, and a central unit 35 for adaptation of the predefined amplitude and/or frequency ratio of the first audio signals relative to the second audio signals, based on the classification index.

The wide variety of applications based on determination of classification index, adapting the predefined amplitude and/or frequency ratio, and reproduction of the signals is shown using the following example.

A speaker 11 is speaking to the listeners 12 using the microphone 26. The speech produces audio waves that are captured by the microphone 26 and transformed into electrical signals. These electrical signals are treated by the transmitting unit 22, and are finally transmitted over the radio communication channel 27 by means of the antenna 23. The radio waves propagate through the air, and are received by the receiving antenna 25 connected to the receiving unit 24. The electrical waves are then transmitted by the receiving unit 24 to the listener's 12 hearing instrument 15. The processing module 33 processes the received electrical signals according to the common signal processing methods and algorithms, and transmit them to the classification unit 34. The integrated microphone 36 captures environmental sounds in the proximity of the listener 12. These sound waves are then transformed by the processing modules 37, and also transmitted to the classification unit 34. Classification unit 34 performs the determination of the classification index based on the amplitude and/or frequency and/or temporal characteristics of the audio signals received through the radio communication channel 27 from the remote speaker 11 and/or the audio signals corresponding to the environmental sounds received from the microphone 36. The determination of the classification index can be based on temporal and/or spectral analysis of the signals, as well as on any other analysis method, including auditory scene analysis as performed by many hearing instruments. The system may be implemented in such a way that the classification index only takes a limited number of predefined values, corresponding for instance to the most common and most typical auditory situations: quiet environment without background noise, loud background noise, one single speaker, own voice, a multitude of speakers etc. The classification index may, however, also be defined so as to take any one value out of a predefined range. This permits an exact determination of the index and a finer tuning of the corresponding FM advantage. Once determined, the value of the classification index is used by the central unit 35 to adapt correspondingly the ratio of amplitudes and/or frequencies of the audio signals proceeding from the remote speaker 11 and audio signals corresponding to the environmental sound, adjusting in this way the FM advantage in the hearing instrument 15. The adapted audio signals are then transmitted to the loudspeaker 38 or any other adequate reproduction means and output to the listener's 12 ear 39.

Another example of the applications based on dynamic loudness adaptation of audio signals is the embedment of the classification unit 34 into the transmission unit 22. In this example, the speaker 11 is speaking to the listeners 12 using the microphone 26. The speech produces audio waves that are captured by the microphone 26 and transformed into electrical signals. These signals are transmitted to the transmission unit 22. The same microphone 26 captures the environmental sounds. The electrical signals corresponding to the speech and environmental sounds are treated by the classification unit 34 in order to determine the classification index based on the amplitude and/or frequency and/or temporal characteristics of the audio signals. Once determined, the value of the classification index and other control data are transmitted to the receiving unit 24 over the radio communication channel 27 at the same time as the audio signals proceeding from the microphone 26 and corresponding to the speaker's 11 speech and environmental sounds. The audio signals and the control data containing the classification index are then used by the central unit 35 to adapt correspondingly the ratio of amplitudes of the audio signals coming from the remote speaker 11, adjusting in this way the FM advantage in the hearing instrument 15. The adapted audio signals are then transmitted to the loudspeaker 38 or any other adequate reproduction means and output to the listener's 12 ear 39.

In another example, the receiving unit 31 uses then the audio signals and the control data containing the classification index to adapt correspondingly the amplitude of the audio signals coming from the remote speaker 11 via the amplifier 32, adjusting in this way the FM advantage in the hearing instrument 15. The adapted audio signals are then transmitted to the hearing instrument 15 and output to the listener's 12 ear 39 via the loudspeaker 38 or any other adequate reproduction means.

Another use of the system and method according to the invention is one in relation to security issues, and particularly the use of hearing assistance systems for members of a security team. One of the major employment situations would be the surveillance of mass events, such as music concerts, sports events or any other similar event with a high concentration of people. It is clear that the correct and clear understanding of both instructions received through the radio channel from the control centre and sounds that can be perceived in the immediate proximity of each member of the team is of utmost importance, so that the use of hearing assistance systems according to the embodiments of the invention can help increase the performance and individual security of each team member.

The system and the method according to the invention can also be used in treating children with an Auditory Processing Disorder (APD), for example, but are not limited thereto. Auditory processing is a term used to describe what happens when your the brain recognizes and interprets the sounds in the surroundings. When speaking of APD we are faced with the situation that something is adversely affecting the processing or interpretation of the information. APD is particularly a problem in children. Children with APD often do not recognize subtle differences between sounds in words, even though the sounds themselves are loud and clear. Problems of this kind are more likely to arise when a person with APD is in a noisy environment or when he or she is listening to complex information. Specialized hearing assistance devices and systems are used to alleviate problems in connection with the APD. The method according to the present invention can be used to adapt the loudness of the signals in the ear depending on the given auditory situation, resulting in better hearing systems.

It will be understood from the foregoing that the invention provides a great advance in hearing assistance systems by creating a dynamic system that provides the optimal ratio between one principal sound source, such as main speaker's voice, and surrounding sounds at any moment and in any possible auditory situation, thereby increasing significantly the comfort of users.

What is claimed is:

1. A method for dynamic loudness adaptation of audio signals in a system for hearing assistance, first audio signals being captured by a first microphone (26) and transmitted by a wireless transmission unit (22) over a communication channel (27) to a receiver (24) connected to or integrated into a hearing instrument (15), and second audio signals being captured by a second microphone (36), characterized in
that a classification index is determined by means of a classification unit (34) based on the amplitude and/or frequency and/or temporal characteristics of the first and/or second audio signals,
that, based on the classification index, the predefined amplitude and/or frequency ratio of the first audio signals relative to the second audio signals is adapted by a central unit (35), and
that the adapted first and second audio signals are reproduced by means of a reproduction unit (38), within the mentioned ratio.

2. The method according to claim 1, characterized in that the determination of the classification index is based on temporal and/or spectral analysis.

3. The method according to claim 1 or 2, characterized in that the determination of the classification index is based on auditory classification techniques.

4. The method according to any one of the claims 1 to 3, characterized in that the classification index takes one of the predefined discrete values.

5. The method according to any one of the claims 1 to 3, characterized in that the classification index takes any one value out of a predefined range.

6. The method according to any one of the claims 1 to 5, characterized in that the classification unit (34) is included in the hearing instrument (15).

7. The method according to any one of the claims 1 to 5, characterized in that the classification unit (34) is included in the receiving unit (24).

8. The method according to any one of the claims 1 to 5, characterized in that the second microphone (36) is included in the receiving unit (24).

9. The method according to any one of the claims 1 to 5, characterized in that the classification unit (34) is included in the transmission unit (22).

10. The method according to claim 9, characterized in
that the first audio signals and control data comprising at least the classification index are sent from the classification unit (34) over the communication channel (27), and
that the predefined amplitude and/or frequency ratio of the first audio signals relative to the second audio signals is adapted based on the received control data.

11. The method according to claim 9 or 10, characterized in that the predefined amplitude and/or frequency ratio of the first audio signals relative to the second audio signals is adapted in the hearing instrument (15) based on the received control data.

12. The method according to claim 9 or 10, characterized in that the predefined amplitude and/or frequency ratio of the first audio signals relative to the second audio signals is adapted in the receiving unit (24) based on the received control data.

13. The method according to any one of the claims 1 to 12, characterized in that the communication channel (27) is a frequency modulation (FM) radio channel.

14. A system for hearing assistance comprising a first microphone (26) for capturing first audio signals and a transmission unit (22) for transmitting the first audio signals over a communication channel (27), a receiving unit (24) for receiving the transmitted first audio signals connected to, or integrated into, a hearing instrument (15), and a second microphone (36) for capturing second audio signals, characterized in that it further comprises
an classification unit (34) for analyzing the first audio signals and the second audio signals and determining a corresponding classification index,
a central unit (35) for adapting the amplitude and/or frequency ratio of the first audio signals relative to the second audio signals based on the classification index, and
a reproduction means (38) for reproducing the adapted first and second audio signals.

15. The system for hearing assistance according to claim 14, characterized in that the determination of the classification index is based on temporal and/or spectral analysis.

16. The system for hearing assistance according to claim 14 or 15, characterized in that the determination of the classification index is based on auditory classification techniques.

17. The system for hearing assistance according to any one of the claims 14 to 16, characterized in that the classification index takes one of the predefined discrete values.

18. The system for hearing assistance according to any one of the claims 14 to 16, characterized in that the classification index takes any one value out of a predefined range.

19. The system for hearing assistance according to any one of the claims 14 to 18, characterized in that the classification unit (34) is included in the hearing instrument (15).

20. The system for hearing assistance according to any one of the claims 14 to 18, characterized in that the classification unit (34) is included in the receiving unit (24).

21. The system for hearing assistance according to any one of the claims 14 to 18, characterized in that the classification unit (34) is included in the transmission unit (22).

22. The system for hearing assistance according to claim 21, characterized in that it comprises
the classification unit (34) for transmitting the first audio signals and control data comprising at least the classification index over the communication channel (27), and
the central unit (35) for adapting the predefined amplitude and/or frequency ratio of the first audio signals relative to the second audio signals based on the received control data.

23. The system for hearing assistance according to claim 21 or 22, characterized in that the unit for adapting the predefined amplitude and/or frequency ratio of the first audio signals relative to the second audio signals based on the received control data is placed in the hearing instrument (15).

24. The system for hearing assistance according to claim 21 or 22, characterized in that the unit for adapting the predefined amplitude and/or frequency ratio of the first audio signals relative to the second audio signals based on the received control data is placed in the receiving unit (24).

25. The system for hearing assistance according to any one of the claims 14 to 24, characterized in that the communication channel (27) is a frequency modulation (FM) radio channel.

26. A system for hearing assistance comprising a microphone (26) for capturing audio signals and a transmission unit (22) for transmitting the audio signals over a communication channel (27), and a receiving unit (24) for receiving the transmitted audio signals, characterized in that it further comprises
a classification unit (34) for analyzing the audio signals and the environmental sounds and determining a corresponding classification index,
a central unit (35) for adapting the amplitude and/or frequency ratio of the audio signals relative to the environmental sounds based on the classification index, and
a reproduction means (38) for reproducing the adapted audio signals.

27. The system for hearing assistance according to claim 26, characterized in that the determination of the classification index is based on temporal and/or spectral analysis.

28. The system for hearing assistance according to claim 26 or 27, characterized in that the determination of the classification index is based on auditory classification techniques.

29. The system for hearing assistance according to any one of the claims 26 to 28, characterized in that the classification index takes one of the predefined discrete values.

30. The system for hearing assistance according to any one of the claims 26 to 29, characterized in that the classification index takes any one value out of a predefined range.

31. The system for hearing assistance according to any one of the claims 26 to 30, characterized in that the classification unit (34) is included in the receiving unit (24).

32. The system for hearing assistance according to any one of the claims 26 to 30, characterized in that the second microphone (26) is included in the receiving unit (24).

33. The system for hearing assistance according to any one of the claims 26 to 30, characterized in that the classification unit (34) is included in the transmission unit (22).

34. The system for hearing assistance according to claim 33, characterized in that it comprises
the classification unit (34) for transmitting the first audio signals and control data comprising at least the classification index over the communication channel (27), and
the central unit (35) for adapting the predefined amplitude and/or frequency ratio of the first audio signals relative to the second audio signals based on the received control data.

35. The system for hearing assistance according to claim 33 or 34, characterized in that the unit for adapting the predefined amplitude and/or frequency ratio of the first audio signals relative to the second audio signals based on the received control data is placed in the receiving unit (24).

36. The system for hearing assistance according to any one of the claims 26 to 35, characterized in that the communication channel (27) is a frequency modulation (FM) radio channel.
